(19) United States
(12) Patent Application Publication
(10) Pub. No.: US 2004/0038703 A1
(43) Pub. Date: Feb. 26, 2004

(54) Folding portable telephone

(76) Inventors: Makoto Noto, Yokohama-shi (JP); Yasuhiko Ota, Yokohama-shi (JP)

Correspondence Address: PEARNE & GORDON LLP, 1801 EAST 9TH STREET, SUITE 1200, CLEVELAND, OH, 44114-3108, US

(21) Appl. No.: 10/380,148

(22) PCT Filed: Apr. 16, 2002
(86) PCT No.: PCT/JP02/03779

(30) Foreign Application Priority Data
Jul. 13, 2001 (JP) 2001-213765

(51) Int. Cl. H04B 7/15

(52) U.S. Cl. 455/550.1; 455/575.3; 455/11.1

(57) ABSTRACT

A problem of the present invention is that, when a mobile phone set has been dropped or so in a folded state of casings and a force of impact has been exerted on either of the upper and lower casings, the force of impact can be restrained from affecting a hinge part to the possible least extent, thereby enhancing reliability of the hinge part, and at the same time, a panel face of a display part is prevented from being damaged due to contact with an operating part.

In order to solve the above described problem, according to the present invention, there is provided a protrusion 5 for preventing sway of the upper casing 1 in a vertical direction when the upper and lower casings are in a folded state, on an end face of the lower casing 2 at its distal end side which is opposite to an end face at a base end side to which the hinge part 3 is fitted. In addition, there are provided protrusions 6 for preventing sway of the upper casing 1 in a lateral direction when the upper and lower casings are in a folded state, on end faces of the lower casing 2 at both sides thereof.

### TECHNICAL FIELD

The present invention relates to a mobile phone set of foldable type in which an upper and a lower casings are connected by way of a hinge part so as to be opened and closed, and more particularly, to the mobile phone set of foldable type in which strength of the hinge part can be enhanced by reducing a force of impact to be exerted to the possible least extent when the mobile phone set has been dropped in a folded state of the casings, and at the same time, damage of a panel face of a liquid crystal display part can be prevented.

### BACKGROUND ART

Various types of mobile phone sets have been developed and used, and among them, there has been known a mobile phone set of foldable type which can be folded into a compact form.

Specifically, this mobile phone set of foldable type is designed in such a manner, as shown in FIG. 2, that an upper casing 101 having a liquid crystal display part and a lower casing 102 having an operating part are mechanically coupled, and an antenna 104 is provided on the lower casing 102.

In this conventional mobile phone set of foldable type, the upper casing 101 and the lower casing 102 have substantially the same size. In other words, they are formed in such a manner that when they are folded, both the casings, except the antenna portion 104, may be overlapped on each other in a substantially perfect alignment.

Moreover, there has been known another conventional mobile phone set of foldable type, as shown in FIG. 3 for example, in which although an upper casing 201 and a lower casing 202 have substantially the same size, similarly to the above, an antenna 204 is provided on the upper casing 201.

However, there have been some cases with these mobile phone sets in which, when the mobile phone set has fallen in a folded state and an excessive force such as load or torsion has been exerted on the upper casing or the lower casing, an enormous load may be given to the hinge part by the force and may lead to a breakdown of the hinge part.

Moreover, in either of these mobile phone sets of foldable type, the antenna portion protrudes outside of the casings, and so, when the mobile phone set has fallen with an end portion having the protruding antenna downward, load of impact will be directly exerted on the antenna.

As a result, there will be an anxiety that the excessive force such as load or torsion accompanying the fall may affect the upper casing or the lower casing by way of the antenna, and when the force has exerted enormous load on the hinge part, the hinge part may be broken down.

Further, in such a mobile phone set of foldable type, when the mobile phone set has fallen in a folded state, keyboard switches and so on in the operating part on the lower casing may get in contact with a panel face of the liquid crystal display part on the upper casing, resulting in damage of the panel face.

Therefore, it is an object of this invention, in view of the above described circumstances, to provide a mobile phone set of foldable type in which, when the mobile phone set has fallen or so in a folded state of the casings and a force of impact or torsion has been exerted on either of the upper and lower casings, the force of impact or the torsion can be restrained from affecting the hinge part to the possible least extent, thereby enhancing reliability of the hinge part, and at the same time, damage of the liquid crystal display part can be prevented.

### DISCLOSURE OF THE INVENTION

According to this invention, there is provided, as a first aspect, a mobile phone set of foldable type, comprising: an upper casing having a display part; a lower casing having an operating part; and a hinge part which couples the casings in a rotatable manner, wherein the upper casing is smaller in width and in length than the lower casing.

Moreover, as a second aspect, there is preferably provided a protrusion is provided for preventing sway of the upper casing in a vertical direction when the upper and lower casings are in a folded state, on an end face of the lower casing at a distal end side which is opposite to an end face at a base end side to which the hinge part is fitted.

With this arrangement, when the mobile phone set has fallen or so in a folded state of the casings and a force of impact has been exerted on either of the upper and lower casings, the force of impact can be restrained from affecting the hinge part by means of the protrusion on the lower casing to the possible least extent, thereby enhancing reliability of the hinge part.

Further, as a third aspect, there is preferably provided a protrusion for preventing sway of the upper casing in a vertical direction when the upper and lower casings are in a folded state, on an end face of the upper casing at a distal end side which is opposite to an end face at a base end side to which the hinge part is fitted.

With this arrangement, when the mobile phone set has fallen or so in a folded state of the casings and a force of impact has been exerted on either of the upper and lower casings, the force of impact can be restrained from affecting the hinge part by means of the protrusion on the upper casing to the possible least extent, thereby enhancing reliability of the hinge part. In addition, because the vertical and lateral sway will be prevented by means of the protrusions, the panel face of the liquid crystal display part on the upper casing can be prevented from being rubbed by the operating part on the lower casing.

Still further, as a fourth aspect, the lower casing may be constructed so as to enclose the upper casing from the vertical direction for preventing sway of the upper casing in a vertical direction by a distal end face of the lower casing when the upper and lower casings are in a folded state.

With this arrangement, when the mobile phone set has fallen or so in a folded state of the casings and a force of impact in a vertical direction has been exerted on either of the upper and lower casings, the force of impact can be restrained from affecting the hinge part by means of the distal end face of the lower casing, thereby enhancing reliability of the hinge part.

### BRIEF DESCRIPTION OF THE DRAWINGS

FIG. 1 shows a mobile phone set of foldable type according to the invention, in which (A) is a plan view, and (B) is a side view.

FIG. 2 shows a conventional mobile phone set of foldable type, in which (A) is a plan view, and (B) is a side view.

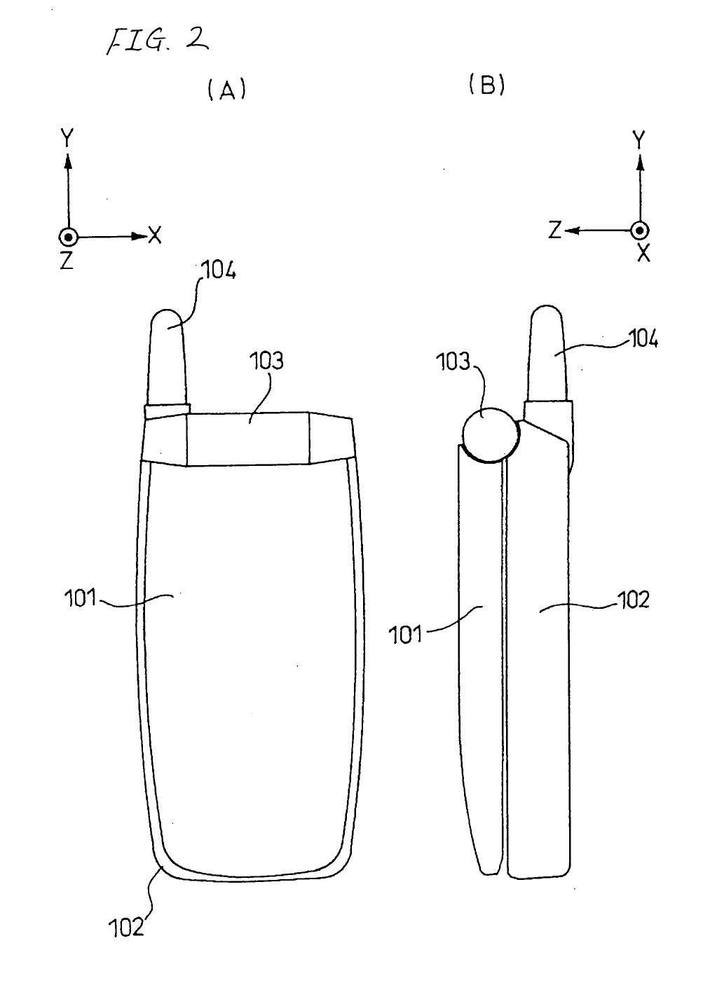

FIG. 3 shows another conventional mobile phone set of foldable type, in which (A) is a plan view, and (B) is a side view.

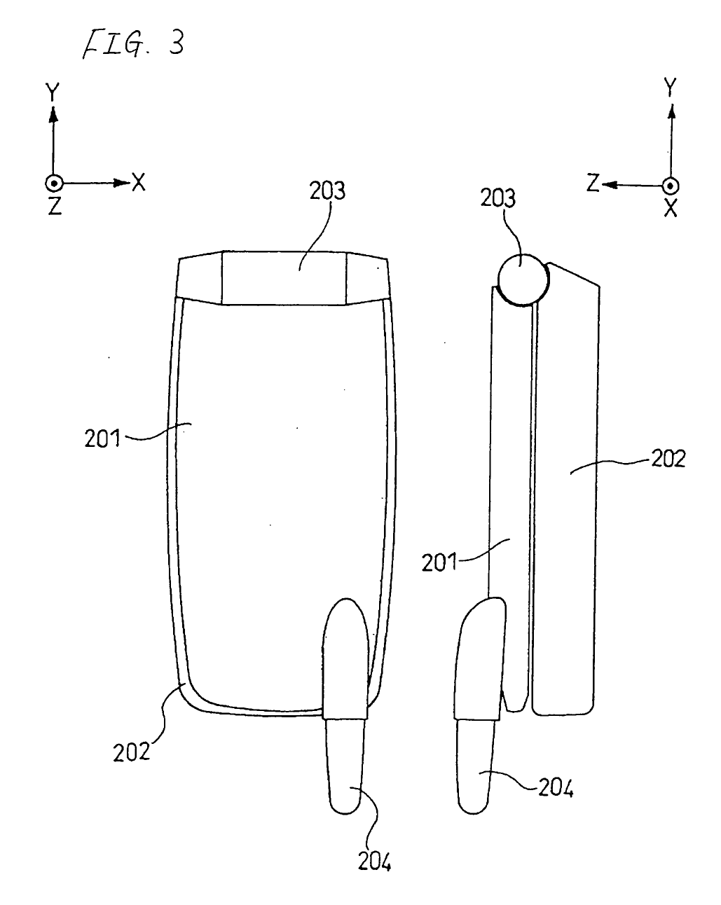

For information, reference numeral 1 in the drawings designates an upper casing, 2 designates a lower casing, 2A designates a dented area, 3 designates a hinge part, 4 designates an antenna, 5 designates a first protrusion, 6 designates a second protrusion, G1 designates a gap (in a vertical direction), and G2 designates a gap (in a lateral direction).

### BEST MODE FOR CARRYING OUT THE INVENTION

Now, an embodiment according to the invention will be described in detail referring to the attached drawings.

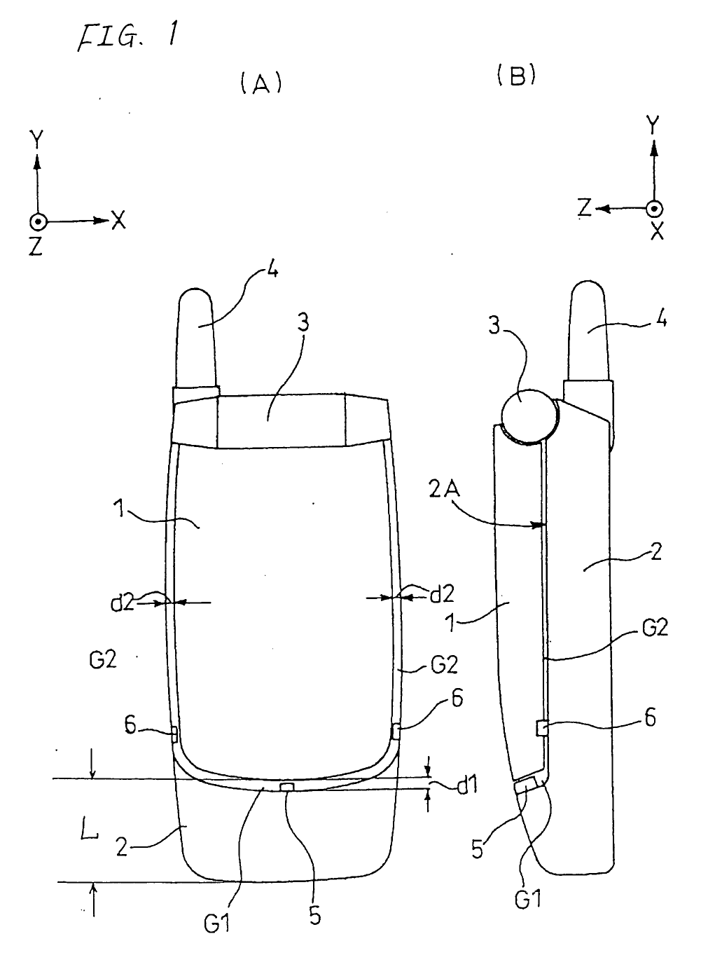

FIG. 1 shows a mobile phone set of foldable type to which the mobile phone set of foldable type according to the embodiment of the invention is applied. This mobile phone set of foldable type has a general structure including an upper casing 1, a lower casing 2, a hinge part 3, an antenna 4, a first protrusion 5, and a second protrusion 6.

The upper casing 1 has a liquid crystal display part, which is not shown in the drawings, on an inner face side thereof, and is formed smaller than the lower casing 2 both in width and in length.

Specifically, the upper casing 1 is formed shorter than the lower casing 2 in size in a lateral (X) direction by a width d2 at both sides thereof. In addition, the upper casing 1 is formed shorter than the lower casing 2 in size in a vertical (Y) direction. Accordingly, when the mobile phone set has been folded into a state where the upper and lower casings are overlapped on each other, a distal end portion of the upper casing 1 opposite to a base end portion which is coupled by the hinge part 3 is shorter by a length L than a distal end portion of the lower casing 2 opposite to a base end portion which is coupled by the hinge part 3.

On the other hand, the lower casing 2 has, on an inner face, an operating part including keyboard switches and so on for conducting various operations which are not shown in the drawings. The lower casing 2 is constructed in such a manner that in order to prevent sway of the upper casing both in a vertical direction and a lateral direction by means of the side faces of the lower casing in a folded state of the upper and lower casings, the lower casing 2 may enclose the upper casing 1 from the vertical (Y) direction and the lateral (X) direction while maintaining certain gaps. In other words, the lower casing 2 is constructed in such a manner that the upper casing 1 may be completely covered by the lower casing 2.

More specifically, the lower casing 2 is provided with a dented area 2A (Refer to FIG. 1(B)) which is dented by a thickness corresponding to the thickness of the upper casing 1 in a direction of thickness (Z) so that the upper casing 1 may not project in the direction of thickness of this lower casing 2. In short, when the upper casing 1 is received in the dented area 2A, the lower casing 2 is adapted to enclose the upper casing 1 from the vertical (Y) direction in a state where a gap G1 having a distance d1 is maintained with respect to the upper casing 1. In the same manner, the lower casing 2 is also adapted to enclose the upper casing 1 from the lateral (X) direction in a state where the lower casing 2 is separated from the upper casing 1 by a distance d2.

Although the antenna 4 is formed on the lower casing 2 in a projecting manner in this embodiment, the antenna 4 may be provided on the upper casing 1 so as to project therefrom.

The first protrusion 5 is intended to prevent sway of the upper casing 1 in the vertical (Y) direction, in the case where an excessive force of impact or torsion has been exerted when the mobile phone set has been dropped or so in a folded state of the upper and lower casings. The first protrusion 5 is provided at a predetermined position on the lower casing 2 which is faced with an end face at the distal end side of the upper casing 1 opposite to an end face at the base end side to which the hinge part 3 is fitted, that is, at the position of the gap G1.

On the other hand, the second protrusions 6 are intended to prevent sway of the upper casing 1 in the lateral direction, in the case where an excessive force of impact or torsion has been exerted when the mobile phone set has been dropped or so in a folded state of the upper and lower casings. This second protrusions 6 are provided at predetermined positions which are faced with end faces at both sides of the upper casing 1, that is, in the respective gaps G2.

Consequently, according to this structure, in the case where the mobile phone set of foldable type has been dropped in a folded state by mistake, even though an excessive load or torsion force has been exerted on the upper casing 1 or the lower casing 2, slip or displacement of the upper casing 1 in the vertical and lateral directions can be restrained, and shock and torsion to be exerted on the hinge part 3 can be remarkably decreased.

In addition, according to this structure, because the vertical and lateral sway can be prevented by the first and second protrusions 5, 6, the panel face of the liquid crystal display part on the upper casing 1 will not be likely to rub against the lower casing 2, and the panel face will be prevented from being damaged. Particularly, because lateral sway of the upper casing 1 is reduced, even on an ordinary occasion of carrying the mobile phone set, the panel face of the liquid crystal display part which is not shown in the drawings can be prevented from rubbing against the operating part such as keyboard switches, and the panel face will become unlikely to be damaged.

It is to be noted that the first and second protrusions 5, 6 are respectively formed integrally with the inner face area of the second casing 2, and composed of pieces having the smallest size that can bear a certain extent of strength and an appropriate shape. Further, although both the first and second protrusions 5, 6 are provided on the lower casing 2 in this embodiment, substantially the same members as these first and second protrusions 5, 6 may be provided on the upper casing 1 at substantially the same positions as in this embodiment.

Still further, it is possible to design the mobile phone set in such a manner that the upper casing 1 can be enclosed from the vertical (Y) direction and the lateral (X) direction, in other words, the upper casing 1 can be completely covered, without employing these first and second protrusions 5, 6, so that when the upper and lower casings 1, 2 have fallen in a folded state, the lower casing 2 can bear the shock and torsion, thereby preventing forces to be applied to the upper casing 1 in various directions.

Although the present invention has been fully described with reference to the specified embodiments, it is apparent to those skilled in the art that various changes and modifications can be added to the invention without departing from sprit and scope of the present invention.

The present application is based on Japanese Patent Application No. 2001-213765 filed on Jul. 13, 2001, the contents of which are hereby incorporated by reference.

<Industrial Applicability>

As described herein above, according to this invention, in the mobile phone set of foldable type, when the mobile phone set has been dropped in a folded state of the casings, and a force of impact has been exerted on either of the upper and lower casings, the force of impact can be prevented from affecting the hinge part by means of the protrusions to the possible least extent, thereby enhancing reliability of the hinge part.

In addition, according to this invention, because the vertical and lateral sway can be prevented by the protrusions, the liquid crystal display part on the upper casing will become unlikely to rub against the operating part on the lower casing, and damage of the panel face can be also prevented.

1. A mobile phone set of foldable type, comprising: an upper casing having a display part; a lower casing having an operating part; and a hinge part which couples the casings in a rotatable manner,
wherein the upper casing is smaller in width and in length than the lower casing.

2. The mobile phone set of foldable type as claimed in claim 1, wherein a protrusion is provided for preventing sway of the upper casing in a vertical direction when the upper and lower casings are in a folded state, on an end face of the lower casing at a distal end side which is opposite to an end face at a base end side to which the hinge part is fitted.

3. The mobile phone set of foldable type as claimed in claim 1, wherein a protrusion is provided for preventing sway of the upper casing in a vertical direction when the upper and lower casings are in a folded state, on an end face of the upper casing at a distal end side which is opposite to an end face at a base end side to which the hinge part is fitted.

4. The mobile phone set of foldable type as claimed in claim 1, wherein, the lower casing is constructed so as to enclose the upper casing from the vertical direction for preventing sway of the upper casing in a vertical direction by a distal end face of the lower casing when the upper and lower casings are in a folded state.
